(19) United States
(12) Patent Application Publication
(10) Pub. No.: US 2017/0004799 A1
(43) Pub. Date: Jan. 5, 2017

(54) OUTPUT BUFFER CIRCUIT CONTROLLING SLEW SLOPE AND SOURCE DRIVER COMPRISING THE SAME AND METHOD OF GENERATING THE SOURCE DRIVE SIGNAL THEREOF

(71) Applicant: SAMSUNG ELECTRONICS CO., LTD., Suwon-si (KR)

(72) Inventors: Gyu-Sung PARK, Hwasung-City (KR); Seungjung LEE, Hwasung-City (KR); Ho Hak RHO, Hwasung-City (KR); Junkwan PARK, Hwasung-City (KR)

(73) Assignee: SAMSUNG ELECTRONICS CO., LTD., Suwon-si (KR)

(21) Appl. No.: 15/193,314

(22) Filed: Jun. 27, 2016

(30) Foreign Application Priority Data
Jul. 2, 2015 (KR) 10-2015-0094832

(51) Int. Cl. G09G 3/36

(52) U.S. Cl. CPC G09G 3/3688; G09G 3/3677; G09G 3/3696; G09G 2310/0291; G09G 2310/0286; G09G 2300/0809

(57) ABSTRACT

An output buffer circuit is provided. The output buffer circuit includes a fast slew rate (FSR) controller that detects a transition duration of an input voltage, to adjust a magnitude of a detection current generated in the detected transition duration based on information on a slew slope, and to generate a slew rate control signal as the adjustment result, and an output buffer that outputs the input voltage as a source drive signal having a slew rate or a slew slope, which is selected, in response to the slew rate control signal.

### CROSS-REFERENCE TO RELATED APPLICATIONS

This application claims priority under 35 U.S.C. §119 to Korean Patent Application No. 10-2015-0094832 filed Jul. 2, 2015, in the Korean Intellectual Property Office, the entire contents of which are hereby incorporated by reference.

### BACKGROUND

Apparatuses, devices, and methods consistent with the present disclosure relate to a display device, and more particularly, relate to an output buffer circuit, a source driver having the same, and a source drive signal generating method thereof, which control a slew rate or a slew slope.

A method of driving a liquid crystal display device includes line inversion, column inversion, and dot inversion, or the like based on a phase of a data voltage applied to a data line. The line inversion refers to a method of inverting a phase of video data for a pixel row and applying the inverted video data to a data line. The column inversion refers to a method of inverting a phase of video data for a pixel column and applying the inverted video data to a data line. The dot inversion refers to a method of inverting a phase of video data for a pixel row and a pixel column and applying the inverted video data to a data line.

A source driver provides the data voltage to a display panel. Nowadays, a slew rate (SR) is significantly increasing to reduce a driving power of the data voltage provided the source driver. However, slopes of a rising edge and a falling edge of the data voltage increase due to a fast slew rate (FSR) of the data voltage, and thus a large current peak occurs, thereby causing electro-magnetic interference (EMI) and a capacitive noise.

### SUMMARY

It is an aspect to provide a source driver, which effectively controls a slope of an input voltage provided with a fast slew rate, and a driving method thereof.

According to an aspect of an exemplary embodiment, there is provided an output buffer circuit of a source driver for processing input data and providing the processed input data to a display panel, the output buffer circuit comprising a fast slew rate (FSR) controller configured to detect a transition duration of an input voltage to adjust a magnitude of a detection current generated in the detected transition duration based on slew slope information, and to generate a slew rate control signal as the adjustment result; and an output buffer configured to output the input voltage as a source drive signal having a slew rate or a slew slope, which is selected, in response to the slew rate control signal.

According to another aspect of an exemplary embodiment, there is provided a source driver for processing video data and driving a display panel, the source driver comprising a digital-to-analog converter configured to convert the video data into a plurality of analog input signals respectively corresponding to source lines of the display panel; and an output buffer circuit configured to process the plurality of analog input signals based on slew slope information, to convert the processed analog input signals into a plurality of source drive signals having two or more different slew rates or slew slopes, and to transmit the source drive signals to the source lines, respectively, wherein the output buffer circuit allocates a slew rate or a slew slope to each of the plurality of source drive signals by group of source drive signals, or by chip.

According to still another aspect of an exemplary embodiment, there is provided a method of generating a source drive signal for processing an image signal and driving a display panel, the method comprising receiving an analog input signal and slew slope information corresponding to each of source lines of the display panel; detecting a transition duration using a level difference between the analog input signal and an output signal that is fed back and generating a detection current corresponding to the level difference; and controlling a level of the detection current based on the slew slope information, mirroring a level of the controlled detection current, and applying a control operation for pulling up or pulling down an output terminal of the output signal based on the mirrored levels of the controlled detection current.

According to still another aspect of an exemplary embodiment, there is provided an output buffer circuit of a source driver, the output buffer comprising a control signal generator configured to generate slew rate information; and a fast skew rate (FSR) controller that is configured to generate a plurality of source drive signals, and to control a slew rate or a slew slope of the source drive signals based on the slew rate information such that at least one source drive signal has a different slew rate or slew slope from the remaining source drive signals.

### BRIEF DESCRIPTION OF THE FIGURES

The above and other aspects will become apparent from the following description with reference to the following figures, wherein like reference numerals refer to like parts throughout the various figures unless otherwise specified, and wherein

FIG. 1 is a block diagram schematically illustrating a display device according to an exemplary embodiment;

FIG. 2 is a block diagram illustrating a source driver of the display device illustrated in FIG. 1;

FIG. 3 is a block diagram schematically illustrating an output buffer circuit of the source driver illustrated in FIG. 2, according to an exemplary embodiment;

FIG. 4 is a circuit diagram exemplarily illustrating fast skew rate (FSR) controllers of the output buffer circuit illustrated in FIG. 3, according to exemplary embodiments;

FIGS. 5A and 5B are diagrams exemplarily illustrating a configuration and an operation of each of the controllers illustrated in FIG. 4;

FIG. 6 is a circuit diagram exemplarily illustrating one of output buffers of the output buffer circuit illustrated in FIG. 3;

FIG. 7 is a timing diagram schematically illustrating control characteristics of a slew slope of a source driver according to an exemplary embodiment;

FIG. 8 is a timing diagram exemplarily illustrating source drive signals provided from an output buffer circuit according to an exemplary embodiment;

FIG. 9 is a circuit diagram illustrating a FSR controller according to another exemplary embodiment;

FIG. 10 is a block diagram schematically illustrating an output buffer circuit according to another exemplary embodiment;

FIG. 11 is a timing diagram exemplarily illustrating source drive signals provided from an output buffer of the output buffer circuit illustrated in FIG. 10;

FIG. 12 is a timing diagram illustrating source drive signals according to still another exemplary embodiment;

FIG. 13 is a flow chart schematically illustrating a method of generating a source drive signal according to an exemplary embodiment;

FIG. 14 is a block diagram schematically illustrating a display device according to another exemplary embodiment;

FIG. 15 is a timing diagram for describing an effect of exemplary embodiments; and

FIG. 16 is a block diagram illustrating an electronic system including a display device according to an exemplary embodiment.

### DETAILED DESCRIPTION

Aspects and features of exemplary embodiments and a method of accomplishing thereof will become apparent from the following description with reference to the following figures, wherein exemplary embodiments will be described in detail with reference to the accompanying drawings. The inventive concept, however, may be embodied in various different forms, and should not be construed as being limited only to the illustrated exemplary embodiments. Rather, these exemplary embodiments are provided as examples so that this disclosure will be thorough and complete, and will fully convey the concept of the inventive concept to those skilled in the art. The inventive concept may be defined by scope of the claims. Meanwhile, the terminology used herein to describe exemplary embodiments is not intended to limit the scope of the inventive concept. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Spatially relative terms, such as “below”, “beneath”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. Like reference numerals refer to like elements throughout.

It will be understood that, although the terms “first”, “second”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a “first” element, component, region, layer or section discussed below could be termed a “second” element, component, region, layer or section without departing from the teachings of the inventive concept.

Example embodiments are described herein with reference to cross section illustrations that are schematic illustrations of idealized exemplary embodiments. As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. Thus, the regions illustrated in the figures are schematic in nature and their shapes are not intended to illustrate the precise shape of a region and are not intended to limit the scope of the present inventive concept. Now hereinafter will be described exemplary embodiments in conjunction with accompanying drawings.

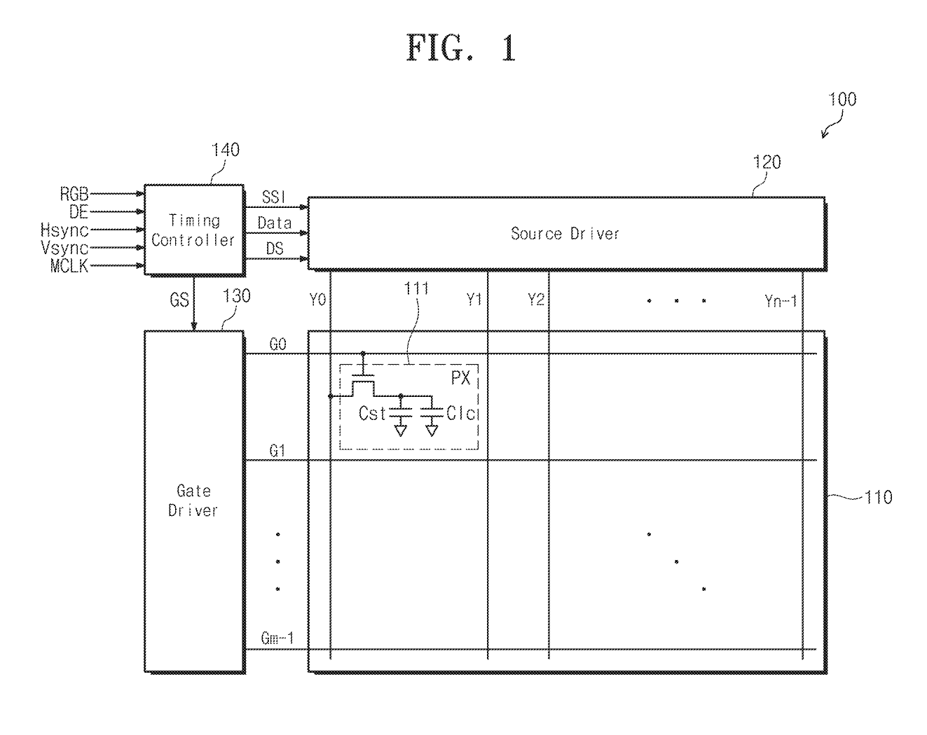

FIG. 1 is a block diagram schematically illustrating a display device according to an exemplary embodiment. Referring to FIG. 1, a display device 100 may include a display panel 110 for displaying an image, a source driver 120, a gate driver 130, and a timing controller 140.

The display panel 110 may include a plurality of pixels (hereinafter referred to as “PX”) connected to a plurality of gate lines and a plurality of source lines respectively. Each of the pixels may correspond to a unit element for displaying an image. A resolution of the display panel 110 may be determined according to the number of the pixels PX. A pixel 111 is illustrated in FIG. 1, and remaining pixels may be omitted. Each of the pixels may display one of primary colors. The primary colors may include, but not limited to, a red color, a green color, a blue color, and a white color. For example, the primary colors may further include various colors such as a yellow color, a cyan color, and a magenta color, and the like.

The source driver 120 may provide source drive signals Y0 to Yn−1 for driving the source lines in response to data Data and a data control signal DS that are provided from the timing controller 140. The source driver 120 may receive the data and may provide the source drive signals Y0 to Yn−1 of a fast slew rate (FSR). Generally, even though the slew rate is fast, a slope of a voltage may not be constant in a rising or falling duration of the source drive signals Y0 to Yn−1. It may be difficult to set a slope in the rising or falling duration of the source drive signals Y0 to Yn−1 because of various circuit conditions. The source driver 120 according to an exemplary embodiment may adjust a slope of an input voltage (hereinafter referred to as “slew slope”) at a high speed.

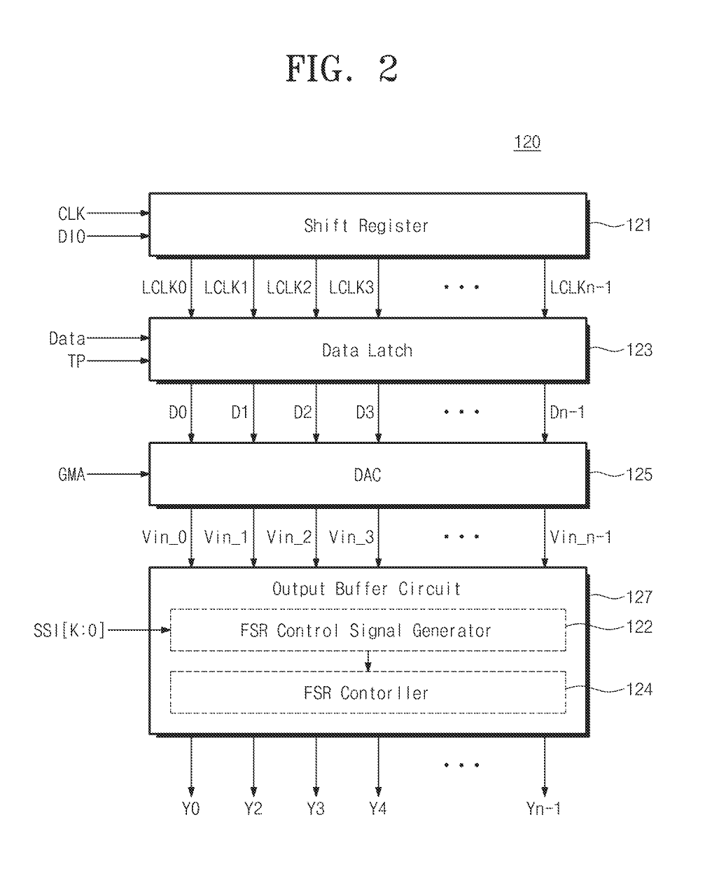

The source driver 120 may adjust a slew slope of each of the source drive signals Y0 to Yn−1 without limitation. The source driver 120 may adjust the slew slope of each of the source drive signals Y0 to Yn−1 based on slew slope information SSI provided from the timing controller 140. For example, the source driver 120 may perform control such that the source drive signals Y0 to Yn−1 have different slew slopes. Alternatively, the source driver 120 may divide the source drive signals Y0 to Yn−1 into a plurality of groups and may perform control such that the groups have different slew slopes from each other. Moreover, the source driver 120 may be implemented with a plurality of chips, and source drive signals Yi from the chips may have different slew slopes under control of the source driver 120. Detailed configurations of the source driver 120 having such a function will be described with reference to FIG. 2 in detail.

The gate driver 130 may sequentially output gate signals G0 to Gm−1 on respective gate lines in response to a gate control signal GS provided from the timing controller 140. A plurality of gate lines may be driven by the gate signals G0 to Gm−1. The gate driver 130 may be implemented with a circuit, which is formed of an amorphous silicon gate (ASG) using an amorphous silicon thin film transistor (a-Si TFT), oxide semiconductor, crystalline semiconductor, polysilicon semiconductor, and the like, and may be formed on the same substrate as that of the display panel 110. In another exemplary embodiment, the gate driver 130 may be implemented with a gate drive integrated circuit (IC), and may be connected to one side of the display panel 110.

The timing controller 140 may receive input image information RGB and a plurality of control signals, which are provided from the outside of the display device 100. The timing controller 140 may convert a data format of the input image information RGB so as to be fit to an interface specification of the source driver 120, and may provide the conversion result to the source driver 120. Moreover, the timing controller 140 may generate the data control signal DS (e.g., an output start signal, a horizontal start signal, or the like) and the gate control signal GS (e.g., a vertical start signal, a vertical clock signal, a vertical clock bar signal) based on the control signals. The data control signal DS may be provided to the source driver 120, and the gate control signal GS may be provided to the gate driver 130.

The timing controller 140 according to an exemplary embodiment may provide the slew slope information SSI to the source driver 120. The slew slope information SSI may be provided from an external device or may be preprogramed fuse data. Based on the slew slope information SSI, the source driver 120 may provide a source drive signal of the FSR and may reduce a current peak generated in a transition duration. This may mean that electromagnetic interference (EMI) or capacitive noise generated in the display device 100 is reduced.

FIG. 2 is a block diagram illustrating a source driver illustrated in FIG. 1. Referring to FIG. 2, the source driver 120 may include a shift register 121, a data latch 123, a digital-to-analog converter (DAC) 125, and an output buffer circuit 127.

The shift register 121 may receive a clock signal CLK and an input/output control signal DIO, and may generate a plurality of latch clock signals LCLK0 to LCLKn−1 based on the clock signal CLK. Each of the latch clock signals LCLK0 to LCLKn−1 may determine a latch point in time of the data latch 123 as a clock signal of a specific period.

The data latch 123 may store data in response to the latch clock signals LCLK0 to LCLKn−1 provided by the shift register 121. The data latch 123 may output the stored data Data to the DAC 125 in response to a load signal TP. The data latch 123 may provide output voltages D0 to Dn−1 in response to the load signal TP. The DAC 125 may generate input voltages Vin_0 to Vin_n−1, which are analog signals corresponding to the output voltages D0 to Dn−1 of the data latch 123, using a gray voltage GMA.

The output buffer circuit 127 may provide the input voltages Vint) to Vin_n−1 as the source drive signals Y0 to Yn−1 based on slew slope information SSI[K:0]. The output buffer circuit 127 may generate the source drive signals Y0 to Yn−1 of FSR. Furthermore, based on the slew slope information SSI[K:0], the output buffer circuit 127 may perform control such that the source drive signals Y0 to Yn−1 respectively have different slew slopes for a group, for a channel, or for a chip. Accordingly, a current peak generated by the same slew slope may be reduced through various changes of a slew rate or a slew slope of the output buffer circuit 127. Furthermore, EMI or a capacitive noise due to the current peak may be reduced.

To provide the above-described function, the output buffer circuit 127 may include a FSR control signal generator 122 and a FSR controller 124. The FSR control signal generator 122 may generate a slew slope control signal corresponding to the slew slope information SSI[K:0] for determining a magnitude of a slew slope. The FSR controller 124 may output the input voltages Vin_0 to Vin_n−1 as the source drive signals Y0 to Yn−1 of FSR having various slew slopes in response to a slew slope control signal.

Above, an example configuration of the source driver 120 according to an exemplary embodiment was described. Based on the slew slope information SSI[K:0], the source driver 120 may provide the input voltages Vin_0 to Vin_n−1 as the source drive signals Y0 to Yn−1 having various slew slopes. Accordingly, a current peak caused by the source drive signals Y0 to Yn−1 of a uniform slew slope may be reduced, and EMI or capacitive noise that affects a display panel may be prevented.

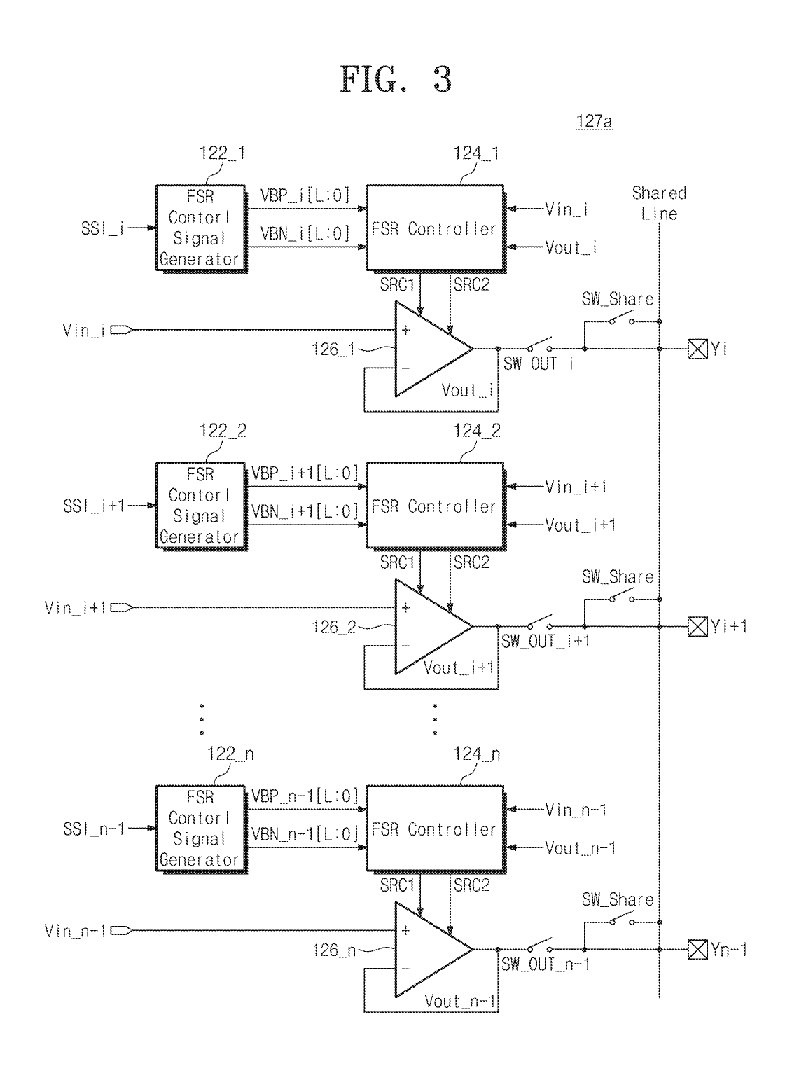

FIG. 3 is a block diagram schematically illustrating an exemplary embodiment of an output buffer circuit illustrated in FIG. 2. Referring to FIG. 3, an output buffer circuit 127a may provide source drive signals Yi to Yn−1 having a slew slope of various levels based on provision of slew slope information SS_i, SSI_i+1, and SSI_i+2. To provide such a function, the output buffer circuit 127a may include FSR control signal generators 122_1 to 122_n FSR controllers 124_1 to 124_n, and output buffers 126_1 to 126_n with respect to each of source lines. Each of the output buffers 126_1 to 126_n may be provided with respective output switches SW_OUT_i in order to control output from the output buffers to the respective source drive signals Yi to Yn−1. Additionally, a shared line may also be provided, and may be connected to the output of the output switches SW_OUT_i through shared line switches SW_Share. Here, an operation of the FSR control signal generator 122_1, the FSR controller 124_1, and the output buffer 126_1 for providing one source drive signal Yi will be described. However, the same operation may be identically applied to the FSR control signal generator 122_j (1≦j≦n, j is a natural number), the FSR controller 124j, and the output buffer 126_j for generating each of the source drive signals Y0 to Yn−1, and therefore a repeated description thereof is omitted.

The FSR control signal generator 122_1 may receive the slew slope information SSI_i for determining a slew rate or a slew slope of the source drive signal Yi. The slew slope information SSI_i may refer to information for determining a magnitude of a slew rate or a slew slope of the source drive signal Yi. The slew slope information SSI_i may be provided from various configurations such as the timing controller 140 illustrated in FIG. 1, a fuse option, or a read only memory (ROM). The slew slope information SSI_i may be selected by a user, and may be programed in a component such as the fuse option. The FSR control signal generator 122_1 may output control signals VBP_i[L:0] and VBN_i[L:0] for controlling the FSR controller 124_1 based on the slew slope information SSI_i. Each of the control signals VBP_i[L:0] and VBN_i[L:0] may be a voltage signal of an analog level for controlling a magnitude of a current generated from the FSR controller 124_1, or may be a switching signal for controlling a plurality of switches that are connected in parallel.

The FSR controller 124_1 may generate slew rate control signals SRC1 and SRC2 for controlling a slew rate of the output buffer 126_1, based on the control signals VBP_i[L:0] and VBN_i[L:0]. Current levels of slew rate control signals SRC1 and SRC2 may be changed according to a current level determined by the control signals VBP_i[L:0] and VBN_i[L:0]. That is, current levels of slew rate control signals SRC1 and SRC2 may be easily changed according to magnitudes or levels of the control signals VBP_i[L:0] and VBN_i[L:0].

The output buffer 126_1 may transmit an input voltage Vin_i as an output voltage Vout_i in response to the slew rate control signals SRC1 and SRC2. Below, the input voltage Vin_i may correspond to the input voltages Vin_0 to Vin_n−1 outputted from the DAC 125. The output voltage Vout_i may be provided as the source drive signal Yi by a switch SW_OUT_i. The output buffer 126_1 may freely adjust a slew rate or a slew slope of the output voltage Vout_i outputted according to a magnitude of the slew rate control signals SRC1 and SRC2. That is, a magnitude of the slew rate control signals SRC1 and SRC2 may be set according to the slew slope information SSI_i. Moreover, the source drive signal Yi, which is an output of the output buffer 126_1, may have a slew rate (SR) or a slew slope (SS) of various magnitudes, based on the slew rate control signals SRC1 and SRC2.

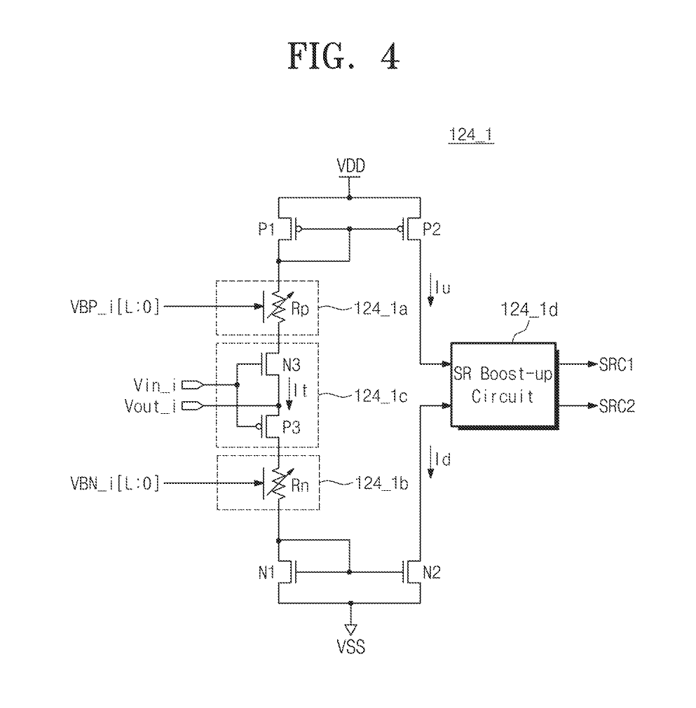

FIG. 4 is a circuit diagram exemplarily illustrating embodiments of a FSR controller illustrated in FIG. 3. Referring to FIG. 4, the FSR controller 124_1 may include current controllers 124_1a and 124_1b, a transition detector 124_1c, and a slew rate (SR) boosting circuit 124_1d. The FSR controller 124_1 may directly adjust a magnitude of a detection current It generated according to a level difference between an input voltage Vin_i and an output voltage Vout_i, using control signals VBP_i[L:0] and VBN_i[L:0]. Moreover, mirroring currents lu and ld of the adjusted detection current It may substantially be provided as the slew rate control signals SRC1 and SRC2, or may be provided to the output buffer 126_1 after being boosted. Here, the input voltage Vin_i and the output voltage Vout_i may denote an input and an output of the output buffer 126_1, respectively.

The transition detector 124_1c may detect a level difference between the input voltage Vin_i and the output voltage Vout_i, which are inputted to the output buffer 126_1. Accordingly, the transition detector 124_1c may include an NMOS transistor N3 and a PMOS transistor P3 of which each gate terminal is supplied with the input voltage Vin_i. When the input voltage Vin_i and the output voltage Vout_i have the same level, a gate voltage and a source voltage of the NMOS transistor N3 or the PMOS transistor P3 may be identical to each other. Accordingly, the NMOS transistor N3 or the PMOS transistor P3 may be kept in a turn-off state. In a duration where the input voltage Vin_i and the output voltage Vout_i are identical to each other, the output voltage Vout_i may kept in the same settling voltage level as the input voltage. Here, the detection current It of the transition detector 124_1c may not be generated.

On the other hand, when the input voltage Vin_i is higher than the output voltage Vout_i, a gate-source voltage of the NMOS transistor N3 or the PMOS transistor P3 may exceed a threshold voltage thereof. Accordingly, the NMOS transistor N3 or the PMOS transistor P3 may be turned on, and the detection current It may be generated.

At this time, the detection current It may be provided to the slew rate boosting circuit 124_1d as a pull-up control current lu and a pull-down control current ld by the PMOS transistors P1 and P2 which are respectively implemented with a current mirror circuit. A magnitude of the pull-up control current lu and the pull-down control current ld may be directly controlled by the control signals VBP_i[L:0] and VBN_i[L:0] provided to the current controllers 124_1a and 124_1b.

The slew rate (SR) boosting circuit 124_1d may adjust the pull-up control current lu and the pull-down control current Id to a level for the output buffer 126_1 and may convert the pull-up control current lu and the pull-down control current Id into voltage-type control signals. The slew rate boosting circuit 124_1d may output the pull-up control current lu and the pull-down control current Id as the slew rate control signals SRC1 and SRC2, respectively. Here, the first slew rate control signal SRC1 may refer to a signal for controlling a slew rate or a slew slope in a rising duration of the output voltage Vout_i. Moreover, the second slew rate control signal SRC2 may refer to a signal for controlling a slew rate or a slew slope in a falling duration of the output voltage Vout_i.

According to the FSR controller 124_1 described above, a level of the detection current It generated by the transition detector 124_1c may be controlled directly by the control signals VBP_i[L:0] and VBN_i[L:0]. Moreover, when the slew rate control signals SRC1 and SRC2 of a value corresponding to a level of the detection current It are provided to the output buffer 126_1, an initial slew slope of the source drive signal Yi may be controlled. As a magnitude of the detection current It generated from the transition detector 124_1c is controlled, pull-up and pull-down operations of the output buffer 126_1 may be controlled at a high speed.

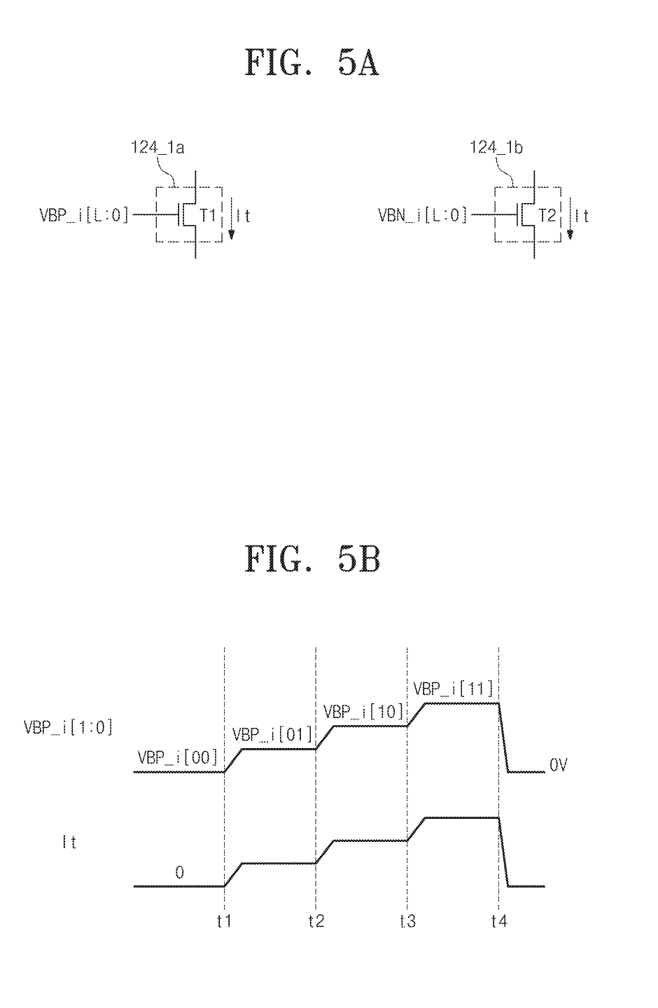

FIGS. 5A and 5B are diagrams exemplarily illustrating a configuration and an operation of each of current controllers 124_1a and 124_1b illustrated in FIG. 4. FIG. 5A illustrates an example configuration of current controllers 124_1a and 124_1b. Referring to FIG. 5A, the current controllers 124_1a and 124_1b may include transistors T1 and T2, respectively, for controlling a magnitude of a current, which flows in a channel, based on a level of a gate voltage.

The first current controller 124_1a may be implemented with the transistor T1 receiving a control signal VBP_i[L:0] as a gate voltage. The transistor T1 included in the first current controller 1.24_1a may be an NMOS transistor of which an aspect ratio of a channel is controlled according to a level of the control signal VBP_i[L:0]. Accordingly, a magnitude of the detection current It which flows in the first current controller 124_1a may be controlled according to a magnitude of the control signal VBP_i[L:0] which is provided as a gate voltage.

The second current controller 124_1b may be implemented with a transistor T2 receiving a control signal VBN_i[L:0] as a gate voltage. The transistor T2 included in the second current controller 124_1b may be an NMOS transistor of which an aspect ratio of a channel is controlled according to a level of the control signal VBN_i[L:0]. Accordingly, a magnitude of the detection current It which flows in the second current controller 124_1b may be controlled according to a magnitude of the control signal VBN_i[L:0] which is provided as a gate voltage.

Here, exemplary embodiments in which the current controllers 124_1a and 124_1b are implemented with NMOS transistors were described. However, the current controllers 124_1a and 124_1b may be alternatively implemented by PMOS transistors or using various switching elements. Moreover, the control signals VBP_i[L:0] and VBN_i[L:0] respectively provided to the current controllers 124_1a and 124_1b may have the same level. That is, the control signals VBP_i[L:0] and VBN_i[L:0] corresponding to slew slope information SSI_i may have the same level. Accordingly, the detection current It of the current controllers 124_1a and 124_1b may be effectively controlled according to the control signals VBP_i[L:0] and VBN_i[L:0].

FIG. 5B is a timing diagram schematically illustrating a magnitude of the detection current It according to a level of the control signal VBP_i[L:0]. Referring to FIG. 5B, the first current controller 124_1a may control a level of the detection current It which flows according to a level of the control signal VBP_i[L:0].

Here, it may be assumed that slew slope information SSI[1:0] for controlling a magnitude of a slew slope (SS) is given as a value for determining four levels. When the slew slope information SSI[L:0] has one of four values SSI[00], SSI[0:1], SSI[10], and SSI[11], each of the control signals VBP_i[1:0] and VBN_i[1:0] outputted as a voltage signal may have four different levels.

For example, the control signal VBP_i[1:0] may have one of four levels VBP_i[00], VBP_i[0:1], VBP_i[10], and VBP:1[11]. Then, the first current controller 124_1a may generate the detection current It controlled according to the four levels VBP_i[00], VBP_i[0:1], VBP_i[10], and VBP[11]. Likewise, although not illustrated, the second current controller 124_[11] may control the detection current It using the control signals VBN_i[00], VBN_i[0:1], VBN_i[10], and VBN_i[11].

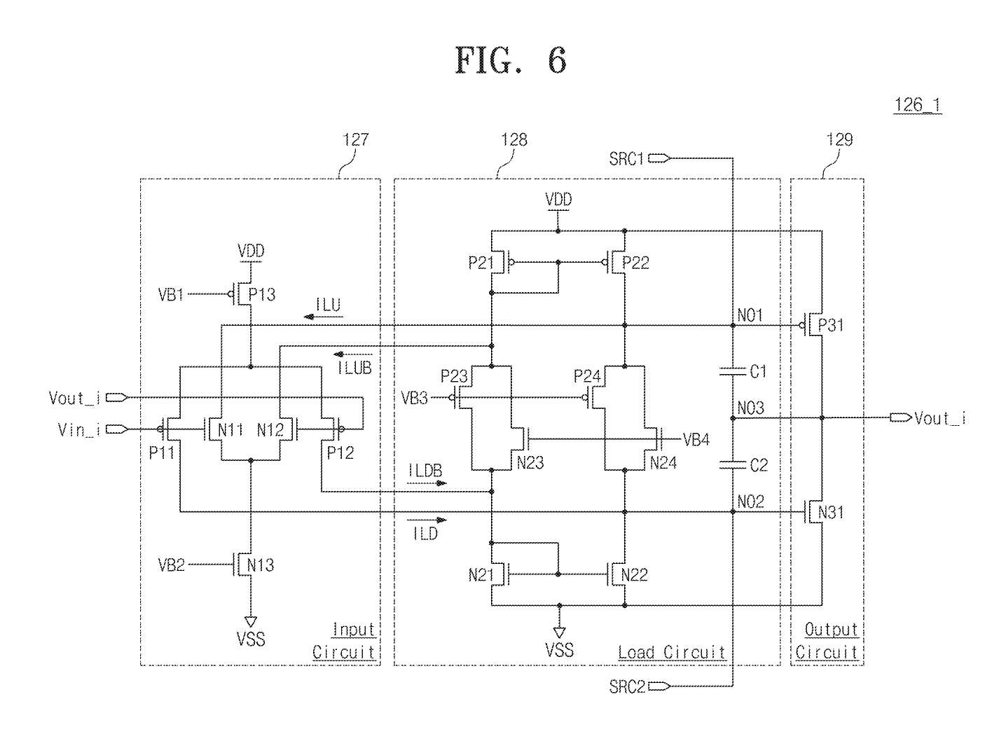

FIG. 6 is a circuit diagram exemplarily illustrating one of the output buffers 126_1, 126_2, and 126_3 illustrated in FIG. 3. Referring to FIG. 6, the output buffer 126_1 may include an input circuit 127, a load circuit 128, and an output circuit 129.

The input circuit 127 may be implemented in the form of a folded-cascode operational transconductance amplifier (OTA). The folded-cascode OTA may convert and transfer a difference between input voltages into a current. The folded-cascode OTA may include a transistor P13 for switching a power voltage VDD by a bias voltage VB1 and PMOS transistors P11 and P12 each connected to the transistor P13. The transistor P13 may provide a constant bias current to the PMOS transistors P11 and P12 in response to the bias voltage VB1.

Furthermore, the input circuit 127 may include a transistor N13 connected to a ground VSS by a bias voltage VB2 and NMOS transistors N11 and N12 each connected to the transistor N13. The transistor N13 may provide a constant bias current to the NMOS transistors N11 and N12 in response to the bias voltage VB2. The NMOS transistors N11 and N12 may generate first and second load currents ILU and ILUB from the load circuit 128 in response to a differential voltage between an input voltage Vin_i and an output voltage Vout_i, respectively. The PMOS transistors P11 and P12 may provide third and fourth load currents ILDB and ILD to the load circuit 128 in response to the differential voltage of the input voltage Vin_i and the output voltage Vout_i, respectively.

As a result, the input circuit 127 may convert the differential voltage between the input voltage Vin_i and the output voltage Vout_i into a magnitude of a current, and may transmit the magnitude of the current to the load circuit 128.

The load circuit 128 may include a first current mirror having PMOS transistors P21 and P22 and a second current mirror having NMOS transistors N21 and N22. The first current mirror and the second current mirror may provide a current to the load circuit 128. The load circuit 128 may include transistors P23 and N23 for connecting a drain terminal of the PMOS transistor P21 and a drain terminal of the NMOS transistor N21 by bias voltages VB3 and VB4. For example, the transistors P23 and N23 may operate as a first floating current source. The load circuit 128 may include transistors P24 and N24 for connecting a drain terminal of the PMOS transistor P22 and a drain terminal of the NMOS transistor N22 by the bias voltages VB3 and VB4. For example, the transistors P24 and N24 may operate as a second floating current source.

The load circuit 128 may include a first capacitor C1 connected between an output node NO3 and a first node NO1 for controlling a pull-up transistor P31 of the output circuit 129. The load circuit 128 may include a second capacitor C2 connected between the output node NO3 and a second node NO2 for controlling a pull-down transistor N31 of the output circuit 129.

The output circuit 129 may include the PMOS transistor P31, which has a gate terminal connected to the first node NO1 corresponding to a drain terminal of the PMOS transistor P22 of the first current minor and is connected between the power voltage VDD and the output node NO3. The output circuit 129 may include NMOS the transistor N31, which has a gate terminal connected to the second node NO2 corresponding to a drain terminal of the NMOS transistor N22 of the second current mirror and is connected between the ground voltage VSS and the output node NO3. Furthermore, a slew rate control signal SRC1 may be provided to the first node NO1, and a slew rate control signal SRC2 may be provided to the second node NO2.

According to an exemplary embodiment, the output buffer 126_1 may make it possible to control a slew slope in transition duration of the output voltage Vout_i using the slew rate control signals SRC1 and SRC2. In transition duration where the input voltage Vin_i is higher than the output voltage Vout_i, the input circuit 127 may increase the first load current ILU and the fourth load current ILDB. Here, a voltage of the first node NO1 of the pull-up transistor P31 in the output circuit 129 may decrease, and thus the slew rate of the output voltage Vout_i may increase. Especially, the slew slope may significantly increase in transition duration of the output voltage Vout_i. Furthermore, in transition duration, a voltage of the first node NO1 of the pull-up transistor P31 may be additionally controlled according to the control signal SRC1 so as to have various levels, and thus a slew slope of the output voltage Vout_i may be adjusted. This may mean that the slew slope of the output voltage Vout_i is variously controlled to have various magnitudes by controlling a magnitude of the slew rate control signals SRC1 and SRC2.

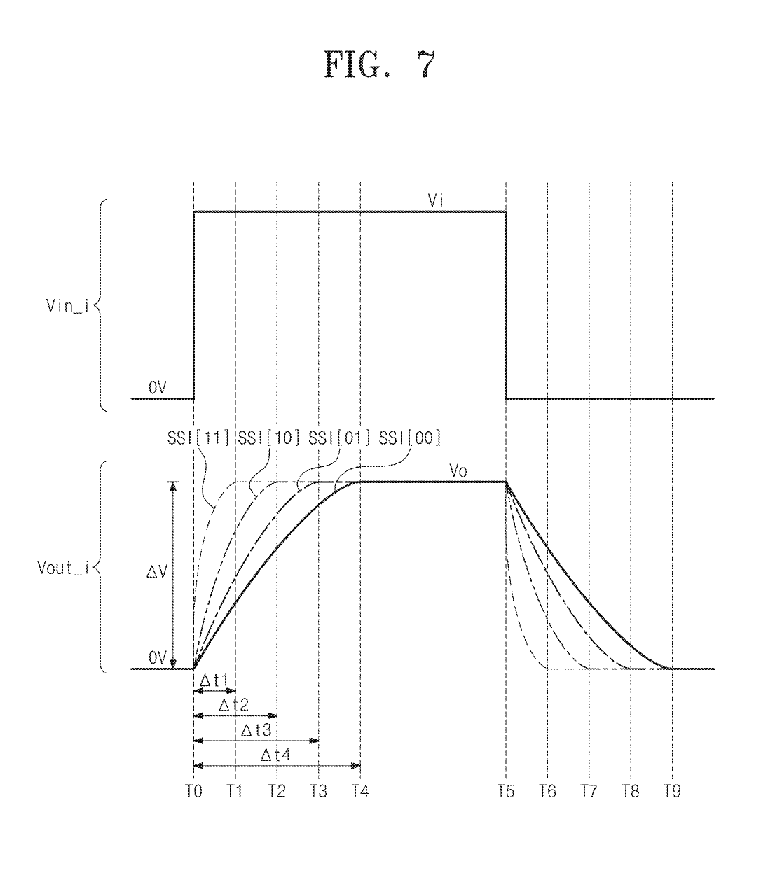

FIG. 7 is a timing diagram schematically illustrating a control characteristic of a slew slope of a source driver according to an exemplary embodiment. Referring to FIG. 7, an input voltage Vin_i inputted to the output buffer circuit 127 may be provided as an output voltage Vout_i of various slew rates (SR) and slew slopes (SS) according to slew slope information (i.e., SSI[1:0]).

For convenience of description, it is assumed that the input voltage Vin_i is provided in the form of an ideal square wave. That is, the input voltage Vin_i may rise from a low level (i.e., 0 V) to a high level Vi at time T0 and may transition from the high level Vi to the low level (i.e., 0 V) at time T5. The output buffer circuit 127 may provide the output voltage Vout_i, which has a slew rate or a slew slope variable according to the slew slope information (SSI[1:0]), based on the input voltage Vin_i.

Firstly, when a magnitude of a slew slope is SSI[00] corresponding to the smallest value, the output voltage Vout_i may start to rise at time T0 and may be settled to a fixed voltage Vo at time T4. In a falling duration, the output voltage Vout_i may start to decrease at time T5 and may be settled to a ground level (i.e., 0 V) at time T9. Accordingly, in the slew slope information (i.e., SSI[00]), a slew rate of the output voltage Vout_i may be illustrated as being Vo/Δt4. Moreover, a rising slope of the output voltage Vout_i may be illustrated as being smallest.

When the slew slope information (SSI) is SSI[0:1], the output voltage Vout_i may start to rise at time T0 and may be settled to the fixed voltage (i.e., Vo) at time T3. In a falling duration, the output voltage Vout_i may start to decrease at time T5 and may be fixed to the ground level (i.e., 0 V) at time T8. In the slew slope information SSI (i.e., SSI[0:1]), a slew rate of the output voltage Vout_i may be illustrated as being Vo/Δt3. That is, a slew rate of the output voltage Vout_i corresponding to the slew slope information of SSI[0:1] may be greater than a slew rate of the output voltage Vout_i corresponding to the slew slope information of SSI[00]. Furthermore, a rising slope of the output voltage Vout_i corresponding to the slew slope information of SSI[0:1] may be greater than a rising slope of the output voltage Vout_i corresponding to the slew slope information of SSI[00].

When the slew slope information is SSI[10], the output voltage Vout_i may start to rise at time T0 and may be settled to the fixed voltage (i.e., Vo) at time T2. Moreover, in a falling duration, the output voltage Vout_i may start to decrease at time T5 and may be fixed to the ground voltage level (i.e., 0 V) at time T7. Accordingly, a slew rate of the output voltage Vout_i may be illustrated as being Vo/Δt2 corresponding to the slew slope information of SSI[10]. That is, a slew rate of the output voltage Vout_i corresponding to the slew slope information of SSI[10] may be greater than a slew rate of the output voltage Vout_i corresponding to the slew slope information of SSI[0:1]. Furthermore, a rising slope of the output voltage Vout_i corresponding to the slew slope information of SSI[10] may be greater than a rising slope of the output voltage Vout_i corresponding to the slew slope information of SSI[0:1].

When the slew slope information is SSI[11], the output voltage Vout_i may start to rise at time T0 and may be settled to the fixed voltage (i.e., Vo) at time T1. Moreover, in a falling duration, the output voltage Vout_i may start to decrease at time T5 and may be fixed to the ground voltage level (i.e., 0 V) at time T6. Accordingly, a slew rate of the output voltage Vout_i may be illustrated as being Vo/Δt1 corresponding to the slew slope information of SSI[11]. That is, a slew rate of the output voltage Vout_i corresponding to the slew slope information of SSI[11] may be greater than a slew rate of the output voltage Vout_i corresponding to the slew slope information of SSI[10]. Furthermore, a rising slope of the output voltage Vout_i corresponding to the slew slope information of SSI[11] may be greater than a rising slope of the output voltage Vout_i corresponding to the slew slope information of SSI[10].

As described above, a magnitude of a slew rate or a slew slope of the output voltage Vout_i may be freely adjusted to have various levels based on a level of the slew slope information. Here, it was described that the slew slope information SSI[1:0] has four levels, but the inventive concept is not limited thereto. The slew slope information may be set to a subdivided level based on the number of bits.

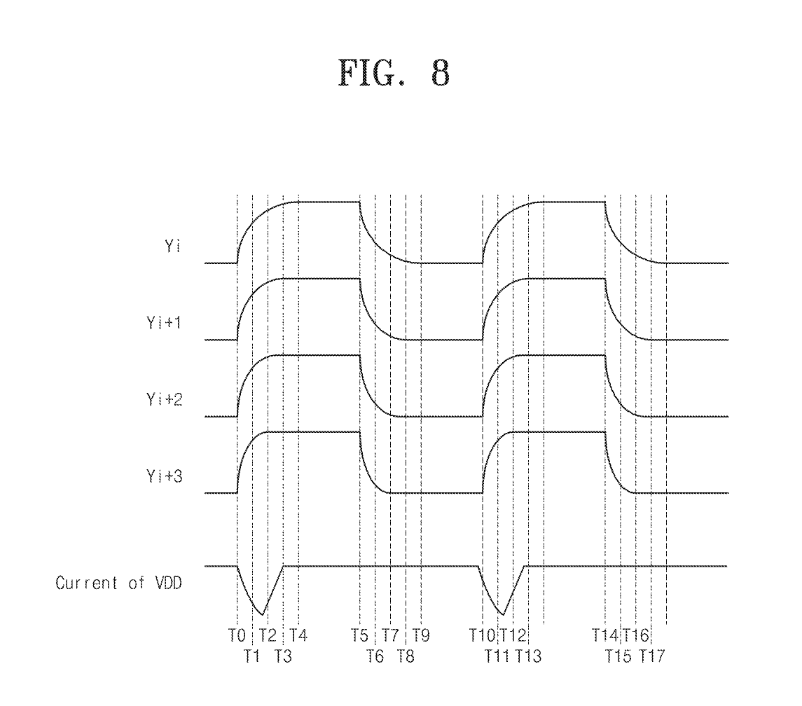

FIG. 8 is a timing diagram exemplarily illustrating source drive signals provided from an output buffer circuit according to an exemplary embodiment. Referring to FIG. 8, the output buffer circuit 127 may adjust a slew rate (SR) or a slew slope (SS) of each of source drive signals Y0 to Yn−1. When a magnitude of a slew rate or a slew slope of each of the source drive signals Y0 to Yn−1 is variously changed, a peak of a current or a power which is consumed at an output time of the source drive signal may be relatively smoothed.

The source drive signal Yi may mean a signal generated by processing an input voltage when the slew slope information is SSI[00]. At this time, a slew rate or a slew slope of the source drive signal Yi may have the lowest value. The source drive signal Yi+1 may mean a signal generated by processing an input voltage when the slew slope information is SSI[0:1]. Here, a slew rate or a slew slope of the source drive signal Yi+1 may have a relatively great value, compared with the source drive signal Yi processed when the slew slope information is SSI[00].

The source drive signal Yi+2 may mean a signal generated by processing an input voltage when the slew slope information is SSI[10]. Here, a slew rate or a slew slope of the source drive signal Yi+2 may have a relatively great value, compared with the source drive signal Yi+1 processed when the slew slope information is SSI[0:1]. The source drive signal Yi+3 may mean a signal generated by processing an input voltage when the slew slope information is SSI[11]. Here, a slew rate or a slew slope of the source drive signal Yi+3 may have a relatively great value, compared with the source drive signal Yi+2 processed when the slew slope information is SSI[10].

A waveform of a power voltage VDD of the output buffer circuit 127 may be substantially changed as illustrated in FIG. 8, at transition times of the source drive signals Yi, Yi+1, Yi+2, and Yi+3. The fluctuations in the power voltage VDD may make a waveform which is relatively smoothed according to different slew rates or slew slopes of the source drive signals Yi, Yi+1, Yi+2, and Yi+3. When the source drive signals Yi, Yi+1, Yi+2, and Yi+3 are set to have the same slew rate or the same slew slope, a current peak may relatively increases, thereby causing EMI or capacitive noise. However, a magnitude of a current peak may significantly decrease by setting the source drive signals Yi, Yi+1, Yi+2, and Yi+3 to have another slew rate or slew slope which is variously changed. Accordingly, EMI or a capacitive noise may be improved.

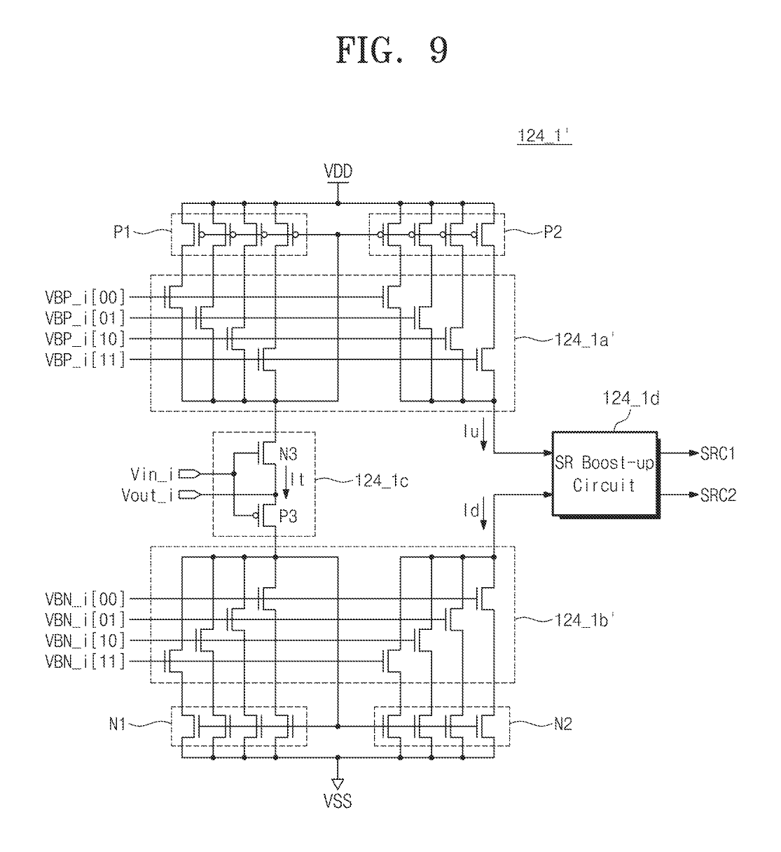

FIG. 9 is a circuit diagram illustrating a FSR controller according to another exemplary embodiment. Referring to FIG. 9, a FSR controller 124_1′ may include current controllers 124_1a′ and 124_1b′, a transition detector 124_1c, and a slew rate (SR) boosting circuit 124_1d. The FSR controller 124_1′ may adjust a magnitude of a detection current It, which is generated according to a level difference between an input voltage Vin_i and an output voltage Vout_i, using control signals VBP_i[L:0] and VBN_i[L:0]. Moreover, mirroring currents lu and Id of the adjusted detection current It may be provided to slew rate control signals SRC1 and SRC2 or may be provided to the output buffer 126_1 after being boosted. The transition detector 124_1c and the slew rate boosting circuit 124_1d may be substantially the same as those in FIG. 4, and a detailed description thereof may be thus omitted.

The transition detector 124_1c may generate the detection current It, and the first current controller 124_1a′ and the second current controller 124_1b′ may control a magnitude of the detection current It. A plurality of first PMOS transistors P1 connected in parallel between a power voltage VDD and the transition detector 124_1c and a plurality of second PMOS transistors P2 connected in parallel between the power voltage VDD and the slew rate boosting circuit 124_1d may constitute a current mirror. Moreover, the first current controller 124_1a′ may adjust a magnitude of a current mirrored using the control signal VBP_i[L:0]. Here, the control signal VBP_i[L:0] may be a switching signal. That is, a magnitude of the detection current It or a magnitude of the mirrored current Iu may be controlled according to the number of transistors, which are turned-on in response to the control signal VBP_i[L:0], from among a plurality of NMOS transistors.

A plurality of first NMOS transistors N1 connected in parallel between a ground voltage VSS and the transition detector 124_1c and a plurality of second NMOS transistors N2 connected in parallel between the ground voltage VSS and the slew rate boosting circuit 124_1d may constitute a current mirror. Moreover, the second current controller 124_1b′ may adjust a magnitude of a current mirrored using the control signal VBN_i[L:0]. Here, the control signal VBN_i[L:0] may be a switching signal. That is, a magnitude of the detection current It or a magnitude of the mirrored current Id may be controlled according to the number of transistors, which are turned-on in response to the control signal VBN_i[L:0], from among a plurality of NMOS transistors.

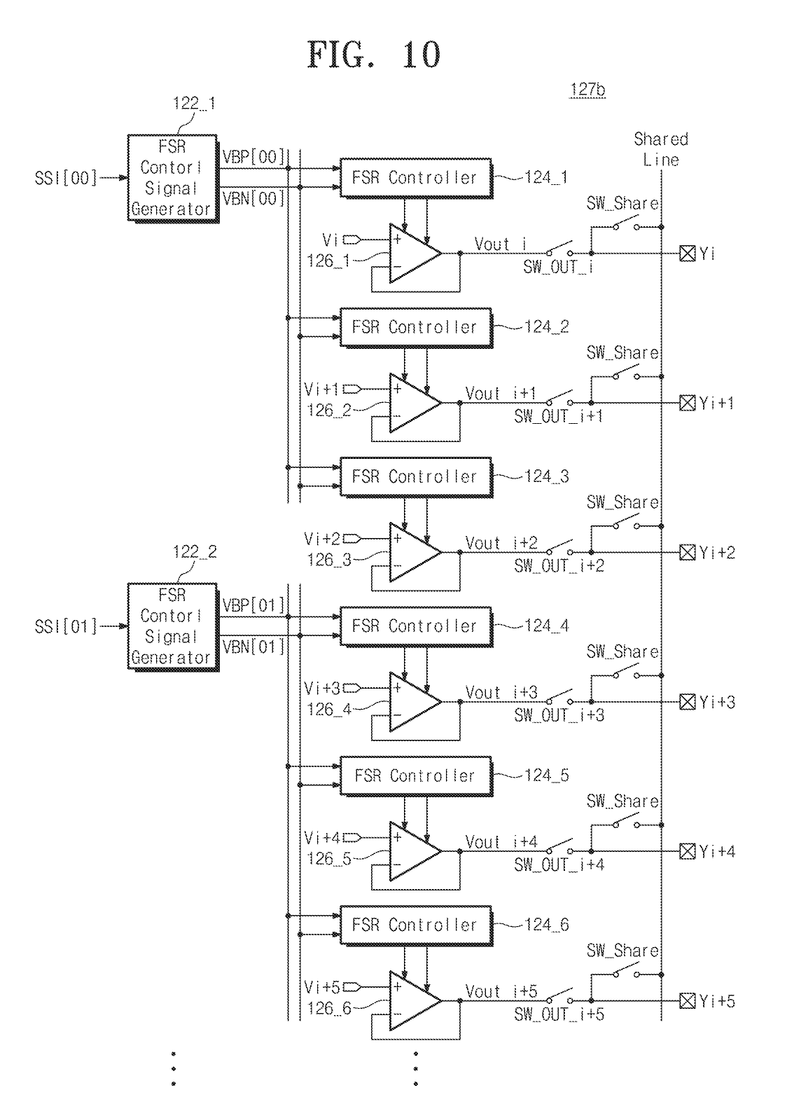

FIG. 10 is a block diagram schematically illustrating an output buffer circuit according to another exemplary embodiment. Referring to FIG. 10, an output buffer circuit 127b may provide source drive signals Yi to Yi+2, Yi+3 to Yi+5, etc. which are divided into source line groups having different slew slopes. To provide such a function, the output buffer circuit 127b may include FSR control signal generators 122_1, 122_2, etc., which are respectively allocated to the source line group Yi to Yi+2, Yi+3 to Yi+5, etc. That is, FSR control signal generator 122_1 is allocated to source line group Yi to Yi+2, and FSR control signal generator 122_2 is allocated to source line group Yi+3 to Yi+5.

The output buffer circuit 127b may include FSR controllers 124_1, 124_2, 124_3, 124_4, 124_5, 124_6, etc. and output buffers 126_1, 126_2, 126_3, 126_4, 126_5, 126_6, etc. For example, one FSR controller (e.g., 124_1) and one output buffer (e.g., 126_1) may be provided for one source line, is shown in FIG. 10. Thus, FSR controller 124_1 and output buffer 126_1 may be provided of source line Yi, and FSR controller 124-3 and output buffer 126_3 may be provided for source line Yi+2, etc. Here, the FSR controllers 124_1, 124_2, 124_3, 124_4, 124_5, 124_6, etc., and the output buffers 126_1, 126_2, 126_3, 126_4, 126_5, 126_6, etc. may be the same as described with reference to FIG. 3, and a detailed description thereof may be thus omitted.

The FSR control signal generator 122_1 may receive slew slope information (i.e., SSI[00]). Here, it is assumed that slew slope information SSI[1:0] having four levels is provided. However, the slew slope information SSI[1:0] may have various levels to improve performance of reducing EMI or capacitive noise of a display device.

The FSR control signal generator 122_1 may receive the slew slope information (i.e., SSI[00]) and may generate control signals VBP[00] and VBN[00] which are an analog signal or a digital signal. Moreover, the FSR control signal generator 122_1 may provide the generated control signals VBP[00] and VBN[00] to the FSR controllers 124_1, 124_2, and 124_3. Each of the FSR controllers 124_1, 124_2, and 124_3 may generate slew rate control signals corresponding to the control signals VBP[00] and VBN[00] and may provide the slew rate control signals to the output buffers 126_1, 126_2, and 126_3. The output buffers 126_1, 126_2, and 126_3 may transmit a first group of source drive signals Yi, Yi+1, and Yi+2 having the same slew rate or slew slope to the display panel 110. A slew rate (SR) or a slew slope (SS) of the first group of source drive signals Yi, Yi+1, and Yi+2 may be set to have a value corresponding to the slew slope information (i.e., SSI[00]).

The FSR control signal generator 122_2 may receive the slew slope information (i.e., SSI[01]) and may generate control signals VBP[0:1] and VBN[0:1]. Moreover, the FSR control signal generator 122_2 may provide the generated control signals VBP[0:1] and VBN[0:1] to the FSR controllers 124_4, 124_5, and 124_6. Each of the FSR controllers 124_4, 124_5, and 124_6 may generate slew rate the control signals SRC1 and SRC2 corresponding to the control signals VBP[0:1] and VBN[0:1] and may provide the slew rate control signals SRC1 and SRC2 to the output buffers 126_4, 126_5, and 126_6. The output buffers 126_4, 126_5, and 126_6 may transmit a second group of source drive signals Yi+3, Yi+4, and Yi+5 having the same slew rate or the same slew slope to the display panel 110. A slew rate or a slew slope of the second group of source drive signals Yi+3, Yi+4, and Yi+5 may be set to have a value corresponding to the slew slope information (i.e., SSI[0:1]).

As a result, the first group of source drive signals Yi, Yi+1, and Yi+2 and the second group of source drive signals Yi+3, Yi+4, and Yi+5 may be controlled to have different slew rates or different slew slopes for a group. Although not illustrated, all source drive signals Y0 to Yn−1 outputted from the output buffer circuit 127b may be generated to have different slew rates or different slew slopes from each other by group, thereby making it possible to remove EMI or a capacitive noise caused by a current peak which is generated due to the same slew rate or the same slew slope.

An exemplary embodiment is exemplified as slew slope information (e.g., SSI[00]) is provided to determine slew rates or slew slopes of three continuous source drive signals Yi, Yi+1, and Yi+2. However, the scope and spirit of the inventive concept may not be limited thereto. That is, the slew slope information (e.g., SSI[00]) may be provided to determine slew rates or slew slopes of two or more continuous source drive signals Yi, Yi+1, and Yi+2. Moreover, the slew slope information (e.g., SSI[00]) may be provided to determine slew rates or slew slopes of two or more discontinuous source drive signals, e.g., Yi, Yi+1024, and Yi+2048.

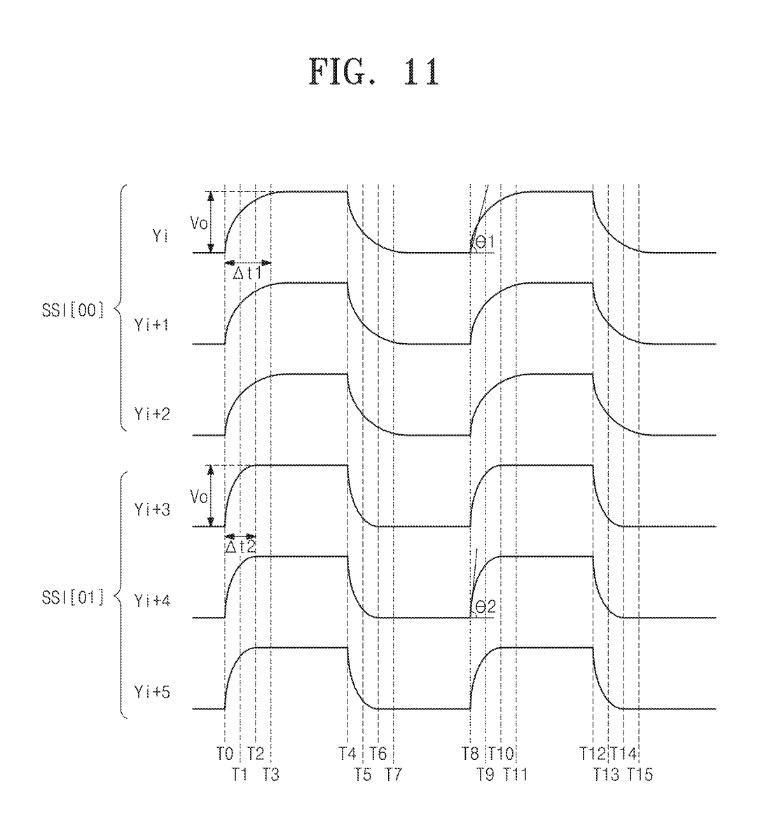

FIG. 11 is a timing diagram exemplarily illustrating source drive signals provided from an output buffer in FIG. 10. Referring to FIG. 11, source drive signals may have different slew rate or different slew slope from each other by group. Here, it is assumed that settling voltages of the source drive signals have the same magnitude Vo.

A first group of the source drive signals Yi, Yi+1, and Yi+2 may be processed based on slew slope information (i.e., SSI[00]). Moreover, a second group of the source drive signals Yi+3, Yi+4, and Yi+5 may be processed based on the slew slope information (i.e., SSI[01]). The first group of the source drive signals Yi, Yi+1, and Yi+2 may have a slew rate and a slew slope smaller than that of the second group of the source drive signals Yi+3, Yi+4, and Yi+5. For example, the first group of the source drive signals Yi, Yi+1, and Yi+2 may have a slew rate (i.e., SR=Vo/Δt1) and a slew slope (i.e., SS=θ₁). Moreover, the second group of the source drive signals Yi+3, Yi+4, and Yi+5 may have a slew rate (i.e., SR=Vo/Δt2) and a slew slope (i.e., SS=θ₂, θ₂>θ₁).

As illustrated in FIG. 11, the source driver 120 illustrated in FIG. 2, according to an exemplary embodiment may control slew rates (SR) or slew slopes (SS) of source drive signals by group, and thus a current peak generated when the source drive signals Y0 to Yn−1 are provided, particularly, when the signals are transitioned may significantly decrease. According to an exemplary embodiment, an EMI- or capacitive noise-free display device may be implemented by setting the source drive signals Y0 to Yn−1 to have various slew rates or slew slopes.

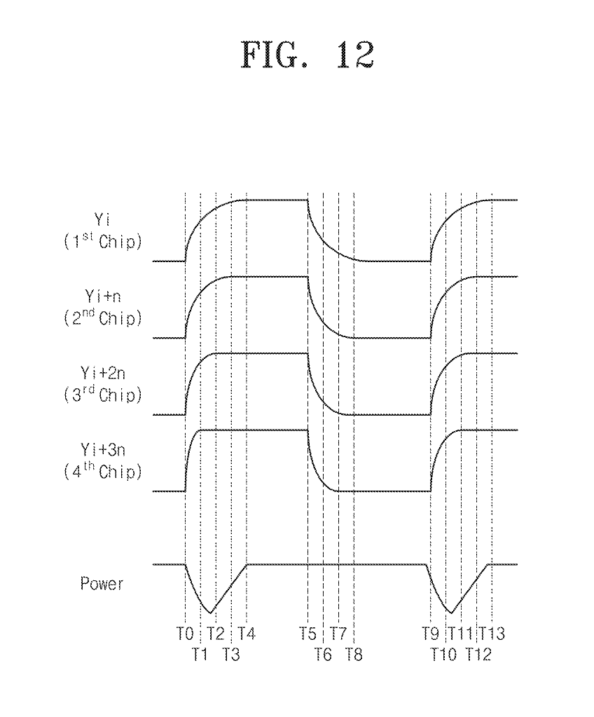

FIG. 12 is a timing diagram illustrating source drive signals according to still another exemplary embodiment. Referring to FIG. 12, source drive signals may be controlled such chips are respectively set to have different slew rates (SR) or slew slopes (SS), in a source driver including a plurality of chips. Here, it is assumed that settling voltages of source drive signals have the same magnitude.

For example, a source driver of a first chip may provide source drive signals Yi processed based on slew slope information (i.e., SSI[00]). A source driver of a second chip may provide the source drive signals Yi+n processed based on the slew slope information (i.e., SSI[0:1]). A source driver of a third chip may provide the source drive signals Yi+2n processed based on the slew slope information (i.e., SSI[10]). A source driver of a fourth chip may provide the source drive signals Yi+3n processed based on the slew slope information (i.e., SSI[11]). Here, an exemplary embodiment is exemplified as each of chips is set by four different slew slope information (i.e., SSI[00], SSI[0:1], SSI[10], SSI[11]). However, the scope and spirit of the inventive concept is not limited thereto. Also, slew slope information may be assigned to the chips by group. Furthermore, each of the chips may process the source drive signals based on at least two slew slope information SSI.

As a slew rate (SR) or a slew slope (SS) of the source drive signal is allocated for chips, a current peak or a power peak of the source driver 120 when source drive signals are provided may be relatively smoothed.

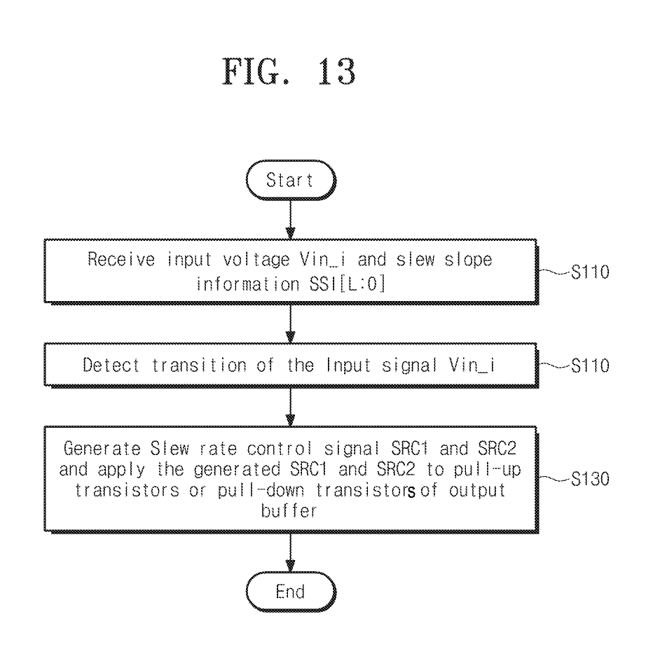

FIG. 13 is a flow chart schematically illustrating a method of generating a source drive signal according to an exemplary embodiment. Referring to FIG. 13, source drive signals having a slew rate (SR) or slew slope (SS) of various magnitudes may be generated according to slew slope information SSI.

In operation S110, the output buffer circuit 127 of the source driver 120 may receive input voltages Vin_i, which are respectively to be provided to the source drive lines Y0 to Yn−1, from the DAC 125. The output buffer circuit 127 may receive slew slope information SSI[L:0] for determining a slew rate or a slew slope of each of the source drive lines Y0 to Yn−1. The slew slope information SSI[L:0] may be provided from an external device through the timing controller 140 or may be provided using a fuse option. The slew slope information SSI[L:0] may be provided such that the source drive lines Y0 to Yn−1 have different slew rates or slew slopes, respectively. Moreover, the slew slope information SSI[L:0] may be provided such that groups of the source drive lines Y0 to Yn−1 have different slew rates or slew slopes, respectively. Furthermore, slew slope information SSI[L:0] may be provided such that the source drive lines Y0 to Yn−1 have different slew rates or slew slopes for chips.

In operation S120, the FSR controller 124_i may detect whether the input voltages Vin_i transition. For example the FSR controller 124_i may use a level difference between the input voltages Vin_i and the output voltage Vout_i of the output buffer 126_i. When an input voltage Vin_i is higher than the output voltage Vout_i, the detection current It may be generated. A duration where the detection current It is generated may be determined as transition duration of the output voltage Vout_i.

In operation S130, the FSR controller 124_i may generate slew rate control signals SRC1 and SRC2 and apply the generated slew rate control signals SRC1 and SRC2 to pull up or pull down transistors of the output buffer 126_i. An amount of a current to be generated may be controlled according to slew slope information SSI[L:0], thereby making it possible to efficiently control a pull-up transistor and a pull-down transistor. Accordingly, a slew rate or a slew slope of the output voltage Vout_i may be controlled in a rising duration of the input voltage Vin _i without limitation.

Slew rates or slew slopes of a plurality of source drive signals Y0 to Yn−1 may be controlled according to the above-described method individually, by group, or by chip. That is, a slew rate or a slew slope of the source drive signal selected by setting the slew slope information SSI[L:0] may be controlled. Accordingly, when the source drive signals Y0 to Yn−1 from the source driver 120 have slew rates or slew slopes of various values, a magnitude of a peak current generated in transition duration of the source drive signals Y0 to Yn−1 may be reduced. This may mean that EMI or capacitive noise generated in the display device 100 may be reduced due to reduction of the peak current.

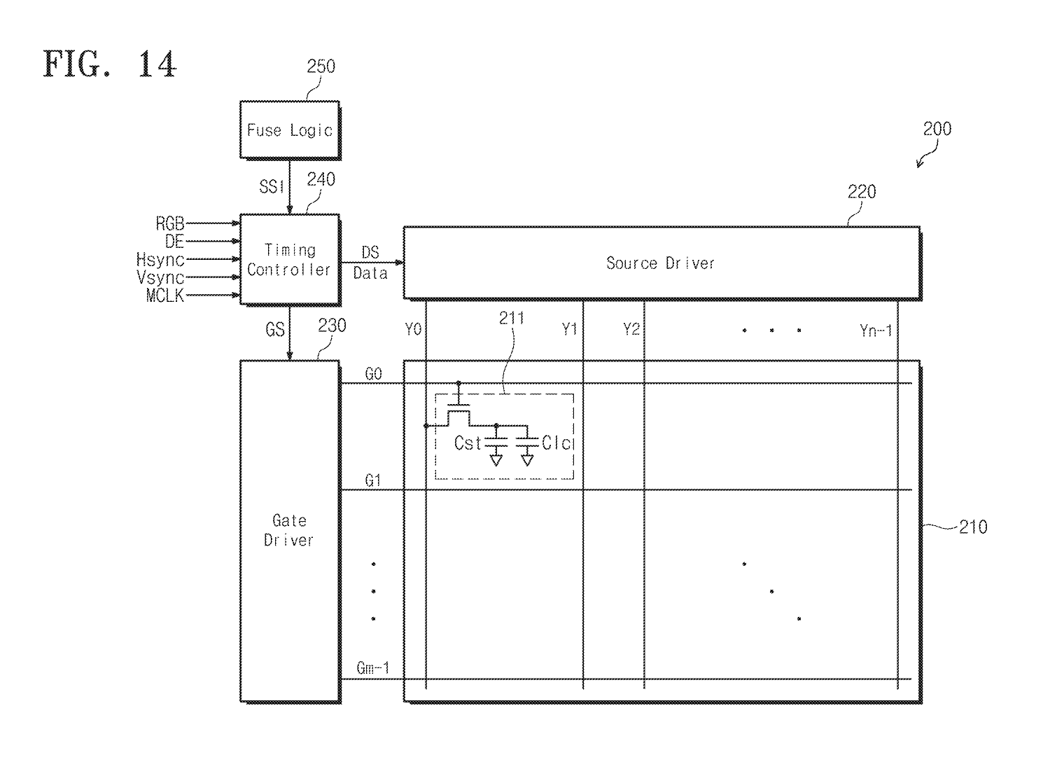

FIG. 14 is a block diagram schematically illustrating a display device according to another exemplary embodiment. Referring to FIG. 14, a display device 200 may include a display panel 210 for displaying an image, a source driver 220, a gate driver 230, a timing controller 240, and fuse logic 250 for setting a value of a slew rate and a slew slope of each of source drive signals Y0 to Yn−1. Here, the display panel 210, the source driver 220, the gate driver 230, and the timing controller 240 are the same as those in FIG. 1, and a description thereof may be thus omitted.

The fuse logic 250 may store slew slope information SSI for setting a value of a slew rate and a slew slope of source drive signals Y0 to Yn−1 outputted from the source driver 220. For example, the fuse logic 250 may provide the slew slope information SSI to the timing controller 240 or the source driver 220 when the display device 200 is booted up or is initialized. The source driver 220 may generate the source drive signals Y0 to Yn−1 each having a fast slew rate and a slew slope of various magnitudes, based on the slew slope information SSI provided from the fuse logic 250.

The source driver 220 according to an exemplary embodiment may provide the source drive signals Y0 to Yn−1 with slew rates or slew slopes of various magnitudes, thereby making it possible to markedly reduce a level of a current peak generated at a transition point in time. The source driver 220 may make it possible to implement a display device free from EMI or capacitive noise generated when a pixel 211 is driven.

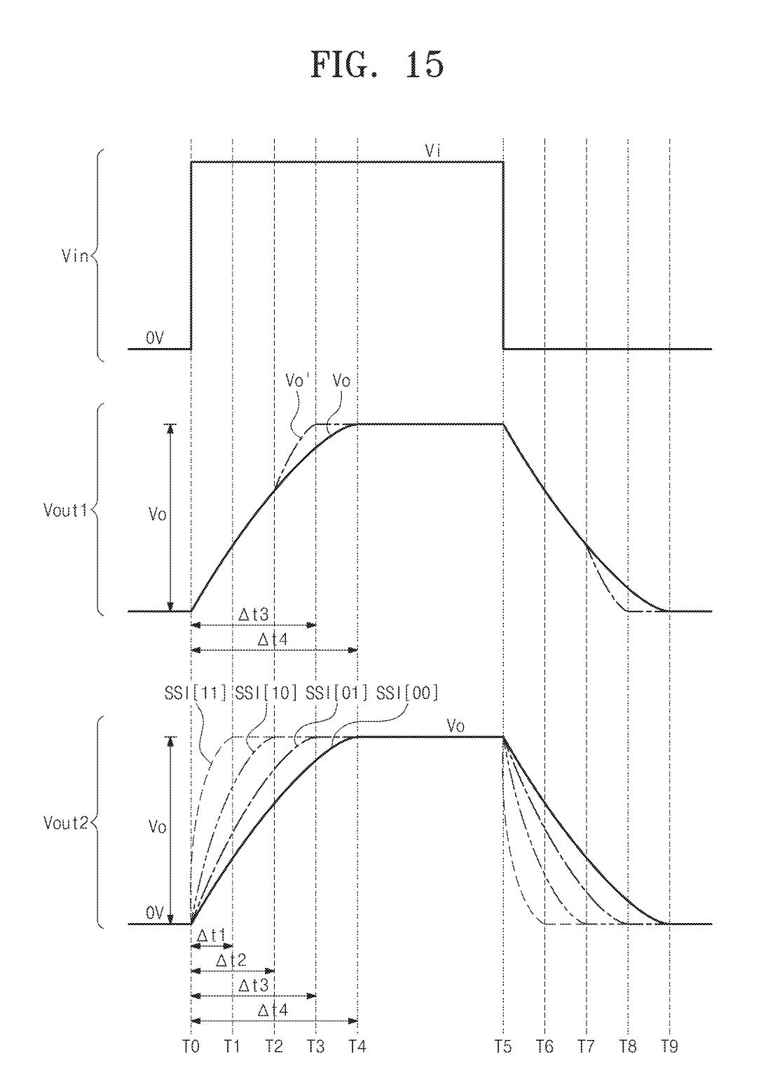

FIG. 15 is a timing diagram for describing an effect of exemplary embodiment. Referring to FIG. 15, an output buffer circuit 127 in which a slew rate (SR) or a slew slope (SS) is easily controlled may be implemented.

When an amount of generation of a detection current It according to an exemplary embodiment is not controlled, a source drive signal may be provided in the form of a first output voltage Vout1 when a slew rate of an output buffer is improved. A slew rate (i.e., SR1=Vo/Δt4) before adjustment may be changed into a slew rate (i.e., SR2=Vo/Δt3) through increase of a slew rate. That is, a waveform Vo may be provided as an output Vo′ in which a slew rate is improved. However, it may be difficult to control a slew slope (i.e., initial slew slope) at a start point T0 of a transition duration.

On the other hand, the FSR controller 124 (refer to FIG. 4) may control the output buffer 126_i based on slew slope information SSI according to an exemplary embodiment. Accordingly, a slew rate (SR) and a slew slope (SS) may be easily controlled. A waveform of the source drive signal based on the slew slope information SSI may be illustrated with a second output voltage Vout2. (see also FIG. 7.)

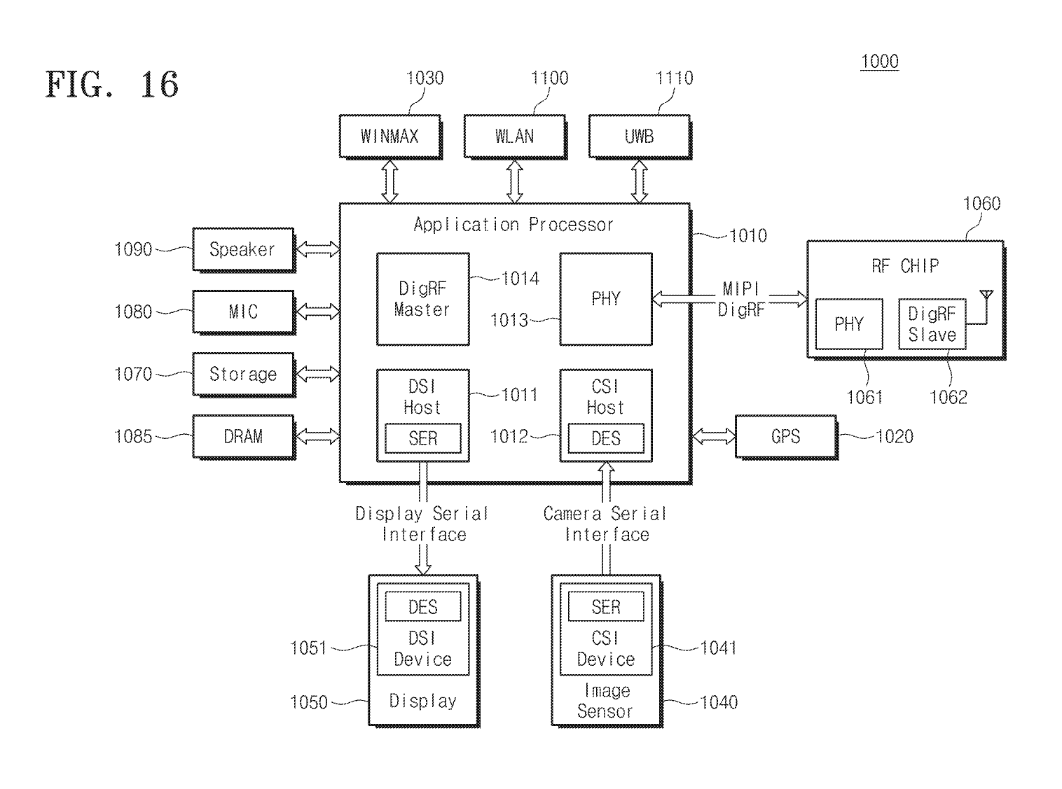

FIG. 16 is a block diagram illustrating an electronic system including a display device according to an exemplary embodiment. Referring to FIG. 16, an electronic system 1000 may be implemented with a data processing device capable of using or supporting a mobile industry processor interface (MIPI), such as a mobile phone, a personal digital assistant (PDA), a portable multimedia player (PMP), or a smartphone. The electronic system 1000 may include an application processor 1010, an image sensor 1040, and a display 1050.

A camera serial interface (CSI) host 1012 included in the application processor 1010 may perform a serial communication with a CSI device 1041 of the image sensor 1040 through CSI. Here, an optical deserializer may be implemented in the CSI host 1012, and an optical serializer may be implemented in the CSI device 1041.

A display serial interface (DSI) host 1011 included in the application processor 1010 may perform a serial communication with a DSI device 1051 of the display 1050 through DSI. Here, an optical serializer may be implemented in the DSI host 1011, and an optical deserializer may be implemented in the DSI device 1051.

The electronic system 1000 may include a radio frequency (RF) chip 1060 capable of communicating with the application processor 1010. A PHY 1013 of the application 1010 and a PHY 1061 of the RF chip 1060 may transmit or receive data based on MIPI DigRF interface. For example, the DigRF interface may include DigRF Master 1014 and DigRF Slave 1062.

The electronic system 1000 may further include a GPS 1020, storage 1070, a microphone (mic) 1080, a DRAM 1085, and a speaker 1090, and the electronic system 1000 may convey communications using worldwide interoperability for microwave access (WiMAX) 1030, wireless local area network (WLAN) 1100, and ultra-wideband (UWB) 1110, or the like.

Here, the display 1050 may include components described with reference to FIGS. 1 to 14. That is, the display 1050 may adjust a slew rate or a slew slope of a plurality of source drive signals so as to have various values. Accordingly, the display 1050 may be free from EMI or capacitive noise generated from the display 1050 provided in the form of a touch panel.

While the inventive concept has been described with reference to certain exemplary embodiments, it will be apparent to those skilled in the art that various changes and modifications may be made without departing from the spirit and scope of the present inventive concept. Therefore, it should be understood that the above exemplary embodiments are not limiting, but illustrative.

1. An output buffer circuit of a source driver for processing input data and providing the processed input data to a display panel, the output buffer circuit comprising:
a fast slew rate (FSR) controller configured to detect a transition duration of an input voltage to adjust a magnitude of a detection current generated in the detected transition duration based on slew slope information, and to generate a slew rate control signal as the adjustment result; and
an output buffer configured to output the input voltage as a source drive signal having a slew rate or a slew slope, which is selected, in response to the slew rate control signal.

2. The output buffer circuit of claim 1, further comprising
a control signal generator configured to convert the slew slope information into control voltages of a plurality of levels and to provide the control voltages to the FSR controller.

3. The output buffer circuit of claim 2, wherein the FSR controller comprises:
a transition detector configured to generate a detection current corresponding to a differential voltage between an input voltage and an output voltage;
a current controller connected to the transition detector, and configured to control a level of the detection current based on the control voltages; and
a current mirror connected to the current controller, and configured to mirror the controlled detection current and to output the mirrored detection current as the slew rate control signal.

4. The output buffer circuit of claim 3, wherein the current controller comprises:
a first current controller connected between a first current mirror for providing a current from a power voltage, and the transition detector; and
a second current controller connected between a second current mirror for sinking a current using grounding, and the transition detector.

5. The output buffer circuit of claim 4, wherein the first current mirror provides a mirroring current corresponding to an amount of a detection current controlled by the first current controller, or the second current mirror provides a mirroring current corresponding to an amount of a detection current controlled by the second current controller, as the slew rate control signal.

6. The output buffer circuit of claim 5, wherein the FSR controller comprises:
a boosting circuit configured to boost the mirroring current and to provide the boosted mirroring current as the slew rate control signal.

7. The output buffer circuit of claim 1, further comprising:
a control signal generator configured to convert the slew slope information into a plurality of switching signals and to provide the switching signals to the FSR controller.

8. The output buffer circuit of claim 7, wherein the FSR controller comprises:
a transition detector configured to generate a detection current corresponding to a differential voltage between the input voltage and an output voltage;
a current controller comprising a plurality of transistors connected in parallel and to the transition detector, the current controller controlling a level of the detection current in response to the plurality of switching signals; and
a current mirror connected to the current controller, and configured to mirror the controlled detection current and to output the mirrored detection current as the slew rate control signal.

9. The output buffer circuit of claim 8, wherein the current controller comprises:
a first current controller comprising first switching transistors connected between a plurality of PMOS transistors, respectively, of a first current mirror for supplying a current from a power voltage to the transition detector in parallel; and
a second current controller comprising second switching transistors connected between a plurality of NMOS transistors, respectively, of a second current mirror for sinking a current by using grounding to the transition detector in parallel.

10. The output buffer circuit of claim 9, wherein the first current mirror provides a mirroring current corresponding to an amount of a detection current controlled by the first current controller, or the second current mirror provides a mirroring current corresponding to an amount of a detection current controlled by the second current controller, as the slew rate control signal.

11. A source driver for processing video data and driving a display panel, the source driver comprising:
a digital-to-analog converter configured to convert the video data into a plurality of analog input signals respectively corresponding to source lines of the display panel; and
an output buffer circuit configured to process the plurality of analog input signals based on slew slope information, to convert the processed analog input signals into a plurality of source drive signals having two or more different slew rates or slew slopes, and to transmit the source drive signals to the source lines, respectively,
wherein the output buffer circuit allocates a slew rate or a slew slope to each of the plurality of source drive signals by group of source drive signals, or by chip.

12. The source driver of claim 11, wherein the output buffer circuit generates a first source drive signal having a first slew rate or a first slew slope in response to first slew slope information, and a second source drive signal having a second slew rate or a second slew slope in response to second slew slope information.

13. The source driver of claim 11, wherein the output buffer circuit generates a plurality of first source drive signals having a first slew rate or a first slew slope in response to first slew slope information, and a plurality of second source drive signals having a second slew rate or a second slew slope in response to second slew slope information.

14. The source driver of claim 13, wherein the plurality of first source drive signals are generated from a first chip, and the plurality of second source drive signals are generated from a second chip different from the first chip.

15. The source driver of claim 11, wherein the slew slope information comprises first slew slope information and second slew slope information, and
wherein the output buffer circuit comprises:
a first fast skew rate (FSR) control signal generator configured to convert the first slew slope information into a first control signal of a voltage level;
a second FSR control signal generator configured to convert the second slew slope information into a second control signal of a voltage level;
a plurality of first output buffers configured to convert a first analog input signal group of the plurality of analog input signals into a first source drive signal group having a slew rate or a slew slope corresponding to the first control signal; and
a plurality of second output buffers configured to convert a second analog input signal group of the plurality of analog input signals into a second source drive signal group having a slew rate or a slew slope corresponding to the second control signal.

16. The source driver of claim 15, wherein the output buffer circuit further comprises:
a plurality of first fast skew rate (FSR) controllers configured to provide a first slew rate control signal corresponding to the first control signal to each of the plurality of first output buffers; and
a plurality of second FSR controllers configured to provide a second slew rate control signal corresponding to the second control signal to each of the plurality of second output buffers,
wherein each of the first FSR controllers and the second FSR controllers mirrors a transition current that is proportional to a differential voltage between an analog input signal and an output signal, and provides the transition current as the first slew rate control signal or the second slew rate control signal.

17. The source driver of claim 16, wherein each of the plurality of first output buffers comprises:
an input circuit configured to convert the differential voltage into a load current;
a load circuit configured to amplify the load current in response to the first slew rate control signal; and
an output circuit configured to pull up or pull down in response to the amplified load current; and
wherein each of the plurality of second output buffers comprises:
an input circuit configured to convert the differential voltage into a load current;
a load circuit configured to amplify the load current in response to the second slew rate control signal; and
an output circuit configured to pull up or pull down in response to the amplified load current.

18. A method of generating a source drive signal for processing an image signal and driving a display panel, the method comprising:
receiving an analog input signal and slew slope information corresponding to each of source lines of the display panel;
detecting a transition duration using a level difference between the analog input signal and an output signal that is fed back and generating a detection current corresponding to the level difference; and
controlling a level of the detection current based on the slew slope information, mirroring a level of the controlled detection current, and applying a control operation for pulling up or pulling down an output terminal of the output signal based on the mirrored levels of the controlled detection current.

19. The method of claim 18, further comprising:
converting the slew slope information into a voltage signal or a logical signal for controlling a magnitude of the detection current.

20. The method of claim 18, wherein the slew slope information is provided to generate two or more source drive signals, having different slew rates or slew slopes, from among source drive signals provided to source lines of the display panel.

21-22. (cancelled)
